(19) United States
(12) Patent Application Publication
(10) Pub. No.: US 2026/0104560 A1
(43) Pub. Date: Apr. 16, 2026

(54) ACTIVE ALIGNMENT FOR MICROLENS ASSEMBLY TO OPTICAL PHASED ARRAY

(71) Applicant: TAARA CONNECT, INC., Sunnyvale, CA (US)

(72) Inventors: Sanam Mozaffari, San Francisco, CA (US); Tymon Barwicz, Holmdel, NJ (US); Andrei Kazmierski, Pleasanton, CA (US); Paul Epp, Sunnyvale, CA (US); Stephen Palese, Menlo Park, CA (US)

(21) Appl. No.: 19/311,707

(22) Filed: Aug. 27, 2025

Related U.S. Application Data
(60) Provisional application No. 63/707,893, filed on Oct. 16, 2024.

(51) Int. Cl. G02B 6/42

(52) U.S. Cl. CPC G02B 6/4225; G02B 6/4227

(57) ABSTRACT

Aspects of the technology provide a system for aligning a lens array of an optical phased array (OPA) architecture. The system may include a photonic integrated circuit (PIC) comprising a portion of the OPA architecture, the portion of the OPA architecture being configured to transmit and receive signals through a lens array; the lens array including an alignment lens array configured to transmit signals therethrough during alignment; a sensor configured to collect measures corresponding to the alignment lens array, the measures being indicative of signals passing through the alignment lens array; and one or more processors operatively connected to the pic, the lens array, and the sensor, the one or more processors configured to: induce the OPA architecture to transmit signals through the alignment lens array, and adjust the lens array relative to a PIC to align the lens array with the PIC based on the measures from the sensor.

### CROSS REFERENCE TO RELATED APPLICATIONS

This application claims the benefit of the filing date of U.S. Provisional Patent Application No. 63/707,893 filed Oct. 16, 2024, the disclosure of which is hereby incorporated herein by reference.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., microelectromechanical systems or voice-coil based fast-steering mirror mechanisms) that are actuated to steer the beam. In other implementations, electrically controllable steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electrically controllable shifting capability.

### BRIEF SUMMARY

Aspects of the disclosure provide a system for aligning a lens array of an optical phased array (OPA) architecture. The system may include a photonic integrated circuit (PIC) comprising a portion of the OPA architecture, the portion of the OPA architecture being configured to transmit and receive signals through a lens array; the lens array including an alignment lens array configured to transmit signals therethrough during alignment; a sensor configured to collect measures corresponding to each lens of the alignment lens array, the measures being indicative of signals passing through the alignment lens array; and one or more processors operatively connected to the pic, the lens array, and the sensor. The one or more processors configured to induce the OPA architecture to transmit signals through the alignment lens array, and adjust the lens array relative to a PIC to align the lens array with the PIC based on the measures from the sensor.

In one example, the alignment lens array may be configured to not transmit signals therethrough during normal operation.

In another example, the alignment lens array may include four lenses disposed in a symmetrical configuration.

In a further example, the lens array may further include a second alignment lens array. Additionally, the alignment lens array and the second alignment lens array may be in a symmetric configuration within the lens array.

In an additional example, the one or more processors may be further configured to move the sensor to a target location of the alignment lens array.

In a further example, the sensor may be a camera or one or more photodiodes (PDs).

In another example, the sensor may include a number of segments corresponding to the number of lenses in the alignment lens array. Additionally, each segment may be configured to detect a measure of one lens of the alignment lens array.

In a further example the lens array may be a micro-lens array of the OPA architecture.

In an additional example, each lens of the alignment lens array may have a diameter in a range of 13 μm to 120 μm.

Another aspect of the disclosure is directed towards a method of aligning a lens array of an OPA architecture. The method may include transmitting, through an alignment lens array of the lens array, a signal to a sensor, the sensor configured to take measures corresponding to each lens of the alignment lens array; collecting, by the sensor, a set of measures of the signal corresponding to each lens of the alignment lens array; and adjusting, by one or more processors, the lens array relative to a PIC based on the set of measures to align the lens array with the PIC, wherein the PIC includes a portion of the OPA architecture.

In one example, the adjusting of the lens array relative to the PIC may occur until the set of measures of the signal corresponding to each lens of the alignment lens array are equal.

In another example, the set of measures may include at least one of power levels, illumination levels, or intensity levels.

In an additional example, the adjusting of the lens array may be in at least one of the x-direction, the y-direction, and the z-direction.

In another example, the method may further include positioning, by the one or more processors, the sensor at a target location of the alignment lens array. Additionally, the target location may be an intended location of transmitted signals. Additionally or alternatively, the method may further include positioning, by the one or more processors, the sensor at a target location of a second alignment lens array.

In another example, the method may further include transmitting, through a second alignment lens array of the lens array, a second signal to the sensor; and collecting, by the sensor, a second set of measures of the signal corresponding to each lens of the second alignment lens array, wherein adjusting, the lens array relative to the PIC is further based on the second set of measures. Additionally, the method may further include transmitting, through the alignment lens array of the lens array, a third signal to the sensor; and collecting, by the sensor, a third set of measures of the signal corresponding to each lens of the alignment lens array, wherein adjusting, the lens array relative to the PIC is further based on the third set of measures.

### BRIEF DESCRIPTION OF THE DRAWINGS

FIG. 1 is a block diagram 100 of a first optical communications terminal and a second optical communications terminal in accordance with aspects of the disclosure.

FIG. 2 is a pictorial diagram 200 of an example system architecture for the first communication terminal of FIG. 1 in accordance with aspects of the disclosure.

FIG. 3 represents features of an OPA architecture represented as an example OPA chip in accordance with aspects of the disclosure.

FIG. 4 is a pictorial diagram of a network in accordance with aspects of the disclosure.

FIG. 5 illustrates an example system in accordance with aspects of the disclosure.

FIG. 6 illustrates an example system in accordance with aspects of the disclosure.

FIG. 7 is a flow diagram in accordance with aspects of the disclosure.

### DETAILED DESCRIPTION

### Overview

The technology relates to alignment of components of an optical communications terminal. Specifically, alignment of a lens array with a photonic integrated circuit (PIC) including portions of an OPA architecture. The lens array and PIC may be configured to transmit and receive signals (e.g., optical communications signals) with remote terminals. In some examples, the alignment may be performed during manufacture.

In this regard, technology may implement a combination of passive fiducial structures and active differential elements in the form of one or more alignment lens arrays included in the lens array. The alignment lens array may allow for sub-micron alignment sensitivity required for lens arrays and PIC grating coupler applications. The sub-micron alignment may enable lens alignment for lens arrays of various types including silicon carrier wafer grating types.

### Example Systems

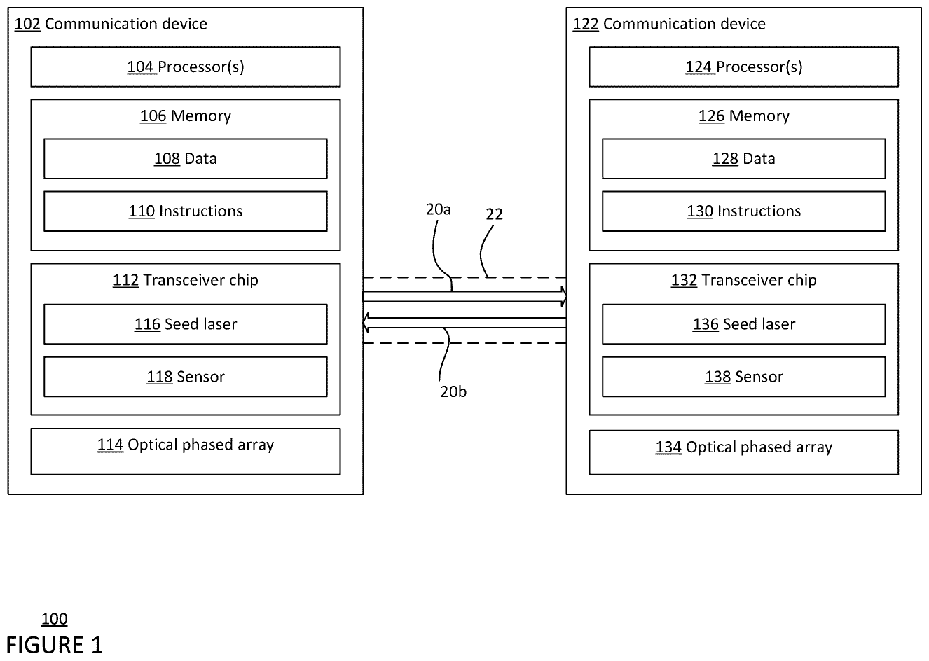

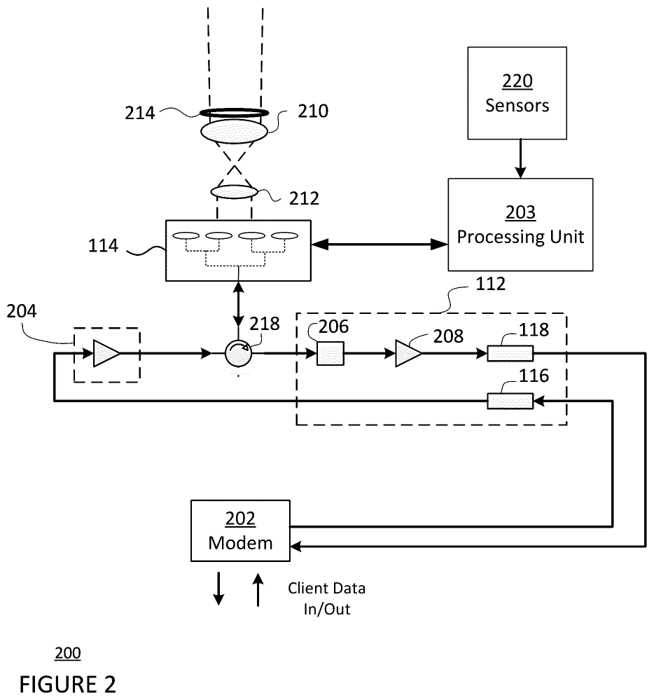

FIG. 1 is a block diagram 100 of a first optical communications terminal configured to form one or more links with a second optical communications terminal, for instance as part of a system such as a free-space optical communication (FSOC) system. FIG. 2 is a pictorial diagram 200 of an example communications terminal, such as the first optical communications terminal of FIG. 1. For example, a first optical communications terminal 102 includes one or more processors 104, a memory 106, a transceiver photonic integrated chip 112, and an optical phased array (OPA) architecture 114. In some implementations, the first optical communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture 114 may include a micro-lens array, an emitter associated with each micro-lens in the array, a plurality of phase shifters, and waveguides that connect the components in the OPA. The OPA architecture may be positioned on a single chip, an OPA chip. The waveguides progressively merge between a plurality of emitters and an edge coupler that connect to other transmitter and/or receiver components. In this regard, the waveguides may direct light between photodetectors or fiber outside of the OPA architecture, the phase shifters, the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA architecture 114 may receive light from the transmitter components and outputs the light as a coherent communications beam to be received by a remote communications terminal or client device, such as second optical communications terminal 122. The OPA architecture 114 may also receive light from free space, such as a communications beam from second optical communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first optical communications terminal 102 may include additional components to support functions of the communications terminal. For example, the first optical communications terminal may include one or more lenses and/or mirrors that form a telescope. The telescope may receive collimated light and output collimated light. The telescope may include an objective portion, an eyepiece portion, and a relay portion. As shown in FIG. 2, the first optical communications terminal may include a telescope including an objective lens 210, an eyepiece lens 212, and an aperture 214 (or opening) through which light may enter and exit the communications terminal. For ease of representation and understanding, the aperture 214 is depicted as distinct from the objective lens 210, though the objective lens 210 may be positioned within the aperture. The first optical communications terminal may include a circulator or wavelength splitter, such as a single mode circulator 218, that routes incoming light and outgoing light while keeping them on at least partially separate paths. The first optical communications terminal may include one or more sensors 220 for detecting measurements of environmental features and/or system components.

The first optical communications terminal 102 may include one or more steering mechanisms, such as one or more bias means for controlling one or more phase shifters, which may be part of the OPA architecture 114, and/or an actuated/steering mirror (not shown), such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first optical communications terminal also includes optical fibers or waveguides connecting optical components, creating a path between the seed laser 116 and OPA architecture 114 and a path between the OPA architecture 114 and the sensor 118.

Returning to FIG. 1, the second optical communications terminal 122 may output the Tx signals as an optical communications beam 20b (e.g., light) pointed towards the first optical communications terminal 102, which receives the optical communications beam 20b (e.g., light) as corresponding Rx signals. In this regard, the second optical communications terminal 122 includes one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second optical communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second optical communications terminal 122 may be included similar to the additional components described above. The second optical communications terminal 122 may have a system architecture that is same or similar to the system architecture shown in FIG. 2.

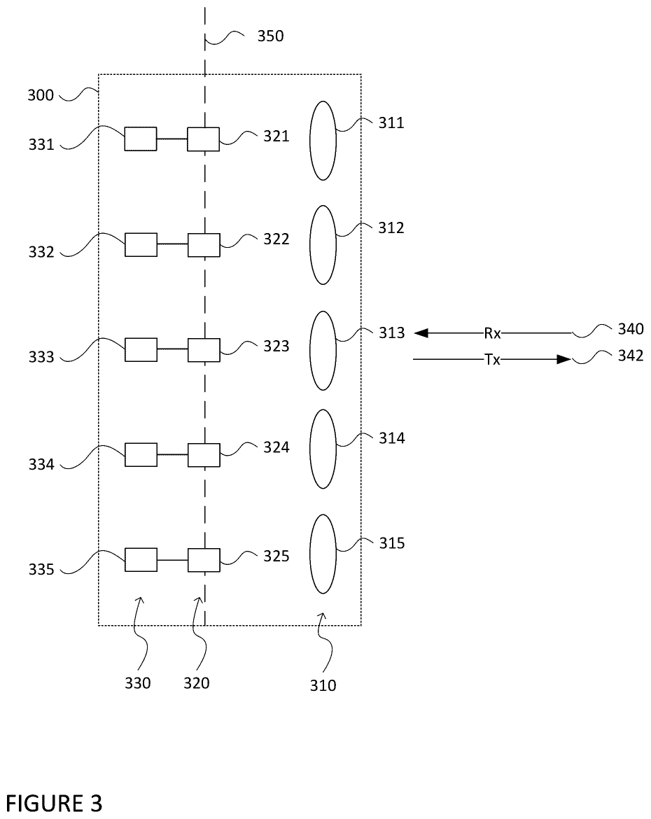

FIG. 3 represent features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 represent the general direction of Tx signals (transmitted optical communications beam) and Rx signals (received optical communications beam) as such signals pass or travel through the OPA chip 300.

The micro-lens array 310 may include a plurality of convex micro-lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10's to 1000's of micrometers in diameter and height. In addition, each micro-lens of the micro-lens array may be manufactured by molding, printing, or etching a lens directly into a wafer of the OPA chip 300. Alternatively, the micro-lens array 310 may be molded, printed, or etched as a separately fabricated micro-lens array. In this example, the micro-lens array 310 may be a rectangular or square plate of glass or silica a few mm (e.g., 10 mm or more or less) in length and width and 0.2 mm or more or less thick. Integrating the micro-lens array within the OPA chip 300 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 320. For example, each micro-lens may have an emitter from which Tx signals are received and to which the Rx signals are focused. As an example, micro-lens 311 is associated with emitter 321. Similarly, each micro-lens 312-315 also has a respective emitter 322-325. In this regard, for a given pitch (i.e., edge length of a micro-lens) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the Tx signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 330 may allow for sensing and measuring Rx signals and the altering of Tx signals to improve signal strength optimally combining an input wavefront into a single waveguide or fiber. Each emitter may be associated with a phase shifter. As shown in FIG. 3, each emitter may be connected to a respective phase shifter. As an example, the emitter 320 is associated with a phase shifter 330. The Rx signals received at the phase shifters 331-335 may be provided to receiver components including the sensor 118, and the Tx signals from the phase shifters 331-335 may be provided to the respective emitters of the plurality of emitters 320. The architecture for the plurality of phase shifters 330 may include at least one layer of phase shifters having at least one phase shifter connected to an emitter of the plurality of emitters 320. In some examples, the phase shifter architecture may include a plurality of layers of phase shifters, where phase shifters in a first layer may be connected in series with one or more phase shifters in a second layer.

A communication link 22 may be formed between the first optical communications terminal 102 and the second optical communications terminal 122 when the transceivers of the first and second optical communications terminals are aligned. The alignment can be determined using the optical communications beams 20a, 20b to determine when line-of-sight is established between the communications terminals 102, 122. Using the communication link 22, the one or more processors 104 can send communication signals using the optical communications beam 20a to the second optical communications terminal 122 through free space, and the one or more processors 124 can send communication signals using the optical communications beam 20b to the first optical communications terminal 102 through free space. The communication link 22 between the first and second optical communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

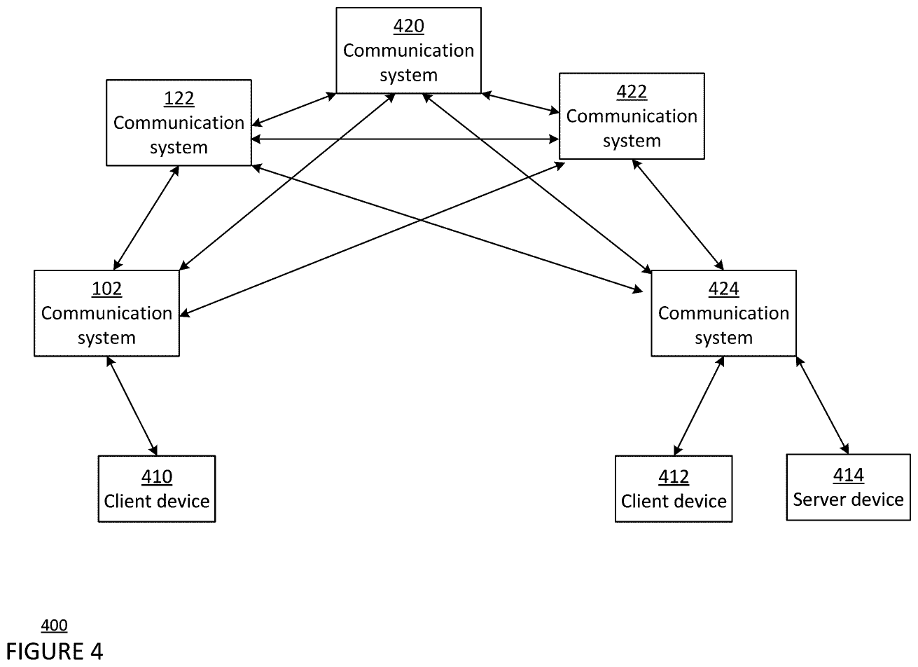

As shown in FIG. 4, a plurality of communications terminals, such as the first optical communications terminal 102 and the second optical communications terminal 122, may be configured to form a plurality of communication links (illustrated as arrows) between a plurality of communications terminals, thereby forming a network 400. The network 400 may include client devices 410 and 412, server device 414, and communications terminals 102, 122, 420, 422, and 424. Each of the client devices 410, 412, server device 414, and communications terminals 420, 422, and 424 may include one or more processors, a memory, a transceiver chip, and an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the first optical communications terminal 102 is shown having communication links with client device 410 and communications terminals 122, 420, and 422. The second optical communications terminal 122 is shown having communication links with communications terminals 102, 420, 422, and 424.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of moveable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

As noted above, the OPA architecture (e.g., OPA architecture 114, 300) or portions thereof of the first optical communications terminal 102 may be included in a PIC. In some instances, a lens array of the OPA architecture may be disposed adjacent to the PIC. The lens array may be a micro-lens array such as micro-lens array 310. The lens array may include a plurality of lenses that focus received signals onto one or more receivers of the OPA architecture and direct transmitted signals to remote terminals. The lens array may be arranged in a grid pattern with a consistent pitch, or distance, between adjacent lenses. In other examples, the lens array may be in different arrangements having different numbers of rows and columns, different shapes, and/or different pitch (consistent or inconsistent) for different lenses. The lens array may include an alignment lens array (e.g., differential alignment features), discussed in more detail below, configured to assist in alignment of the PIC with the lens array.

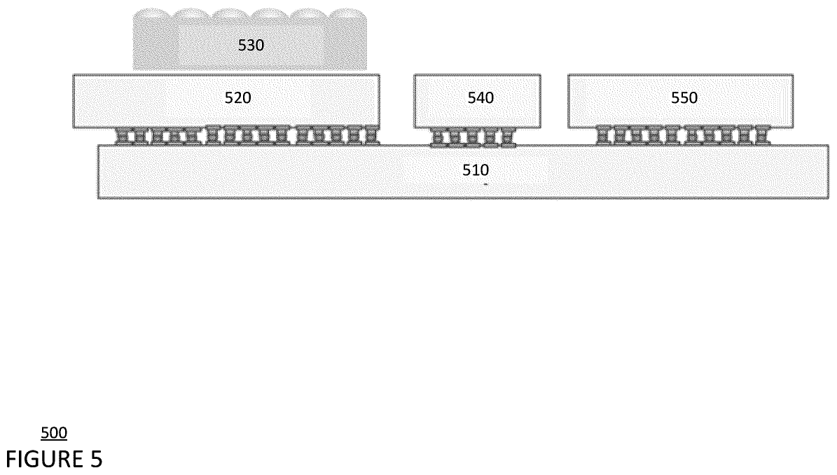

FIG. 5 illustrates an example system 500 of elements included in an optical communications terminal. The system 500 includes an interposer 510, a PIC 520, a lens array 530, and one or more processors. The one or more processors includes a first set of one or more processors 540, and a second set of one or more processors 550. The one or more processors may be configured in the same or similar manner as the one or more processors 104 and/or the one or more processors 124. In some instances, the first set of one or more processors 540 and the second set of one or more processors 550 may each be a dedicated device such as an ASIC.

The interposer 510 may be configured to connect components of the optical communications terminal. In this regard, FIG. 5 illustrates PIC 520, a lens array 530, and the one or more processors operatively connected by interposer 510. In some instances, the interposer may be a silicon (Si) interposer.

PIC 520 may include an OPA architecture (e.g., OPA architecture 114, 300) or portions thereof. The one or more processors may be configured to drive a plurality of phase shifters of the PIC 520 to direct transmitted and received signals. As such, the PIC 520 and OPA architecture thereof may be configured to transmit and receive signals through the lens array 530. In this regard, the lens array 530 may include a plurality of lenses that focus received signals onto one or more receivers of the OPA architecture and direct transmitted signals. The lens array 530 may be arranged in a grid pattern with a consistent pitch, or distance, between adjacent lenses. In other examples, the lens array 530 may be in different arrangements having different numbers of rows and columns, different shapes, and/or different pitch (consistent or inconsistent) for different lenses. In some instances, the lens array 530 may be Si lenses.

The lens array 530 may include an alignment lens array (e.g., differential alignment features) configured to be used in alignment of the PIC with the lens array. The alignment lens array may be configured to transmit signals therethrough during alignment. The alignment lens array may be configured to not transmit signals therethrough during normal operation of the optical communications terminal. The normal operations may include non-alignment operations such as transmitting and receiving signals to and from a remote terminal. During alignment, the one or more processors may be configured to move the lens array 530 with respect to the PIC 520.

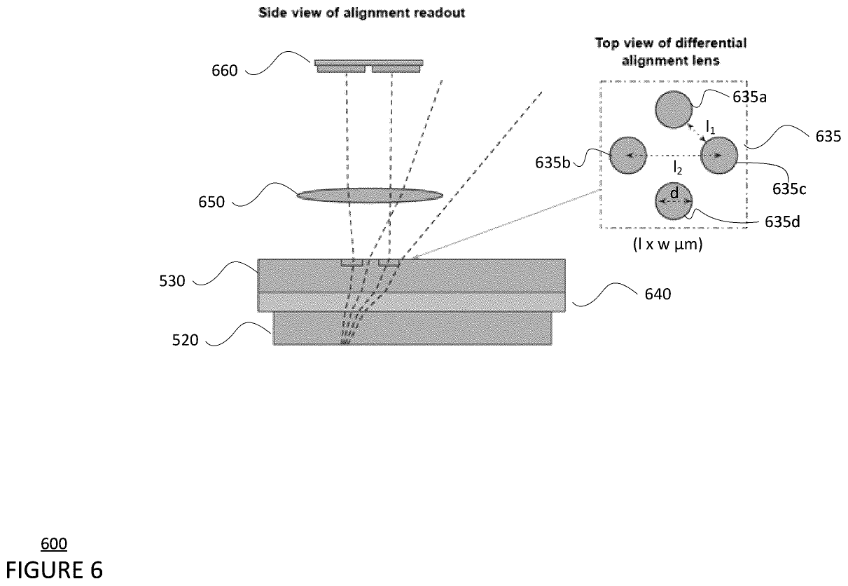

FIG. 6 illustrates an example system 600 for alignment of a PIC 520 with a lens array 530. In some instances, alignment of the PIC 520 and lens array 530 may be performed during manufacture of an optical communication terminal.

The example system 600 includes the PIC 520, the lens array 530, intermediate layer 640, lens 650, and sensor 660. The intermediate layer 640 as illustrated between the PIC 520 and the lens array 530. The intermediate layer 640 may be coupled to the lens array 530 such that the intermediate layer 640 moves with the lens array 530 when the lens array 530 moves relative to the PIC 520. The intermediate layer 640 may be configured to have a low coefficient of thermal expansion (e.g., 3×10⁻⁶ per degree Celsius or more or less). The low coefficient of thermal expansion may allow for less transfer of heat from the PIC 520 to the lens array 530. In some instances, the intermediate layer 640 may be borosilicate glass.

The lens array 530 as illustrated in FIG. 6 includes an alignment lens array 635 (e.g., differential alignment features). The alignment lens array 635 may be configured to transmit signals therethrough during alignment. The alignment lens array 635 may be configured to not transmit signals therethrough during normal operation of the optical communications terminal (e.g., when transmitting and receiving signals to and from a remote terminal). The alignment lens array 635 has a length l and a width w. The length l and the width w may be defined by the extent of the lenses of the array or by a perimeter. In some instances, the length l may be in a range of 53 μm to 480 μm and the width may be in a range of 53 μm to 480 μm. The alignment lens array 635 as illustrated includes four lenses. The four lenses include a first lens 635a, a second lens 635b, a third lens 635c, and a fourth lens 635d. The four lenses may be disposed in a symmetrical configuration, such as a square configuration. In a symmetrical configuration, each lens may be disposed a first distance from adjacent lens and a second distance from an opposite lens. For example, the first lens may be disposed a first distance l₁ from each of the second lens 635b and the third lens 635c and a second distance l₂ from the fourth lens 635d. The first distance l₁ may be on the order of 30 μm or more or less. In some instances, the first distance l₁ may be in a range of 10 μm and 90 μm. The second distance l₂ may be on the order of 100 μm or more or less. In some instances, the second distance l₂ may be in a range of 30 μm to 300 μm. Additionally or alternatively, the diameter d of each lens of the alignment lens array 635 may be on the order of 10 μm or more or less. In some instances, the diameter d of each lens may be in a range of 13 μm to 120 μm. While alignment lens array 635 is illustrated as including four lenses, this is merely for illustrative purposes. In this regard, an alignment lens array may include more than four lenses or less than four lenses.

In some instances, the lens array 530 may include a plurality of alignment lens arrays positioned about the lens array. In one example, the lens array 530 may include two alignment lens arrays 635 in a symmetric configuration (e.g., disposed on opposite sides of an m×n lens array). In another example, the lens array 530 may include four alignment lens arrays 635 in a symmetric configuration (e.g., disposed in each corner of an m×n lens array).

The lenses 635a, 635b, 635c, 635d of the alignment lens array 635 may be configured such that the lenses 635a, 635b, 635c, 635d provide the required sensitivity for the beam size emitted from the PIC 520. The size, shape, number of lenses, and relative distance of the lenses, and a grating emission profile can be specifically tailored for the PIC 520 to lens array 530 configuration.

The configuration of lenses 635a, 635b, 635c, 635d illustrated in FIG. 6 may be used for adjustments in the x-direction and/or the y-direction relative to the lens array 530. In some instances, additional alignment lens array configurations can support radial, hexagonal, octagonal or other geometric shape alignments. Additionally the alignment lens array 635 or other configurations thereof can be utilized to align a lens array 530 in the three-dimensional space (e.g., x-direction and/or the y-direction, and/or z-direction).

During alignment, the PIC 520 may be configured to transmit signals (e.g., optical signals) through the alignment lens array 635 towards sensor 660. Lens 650 may be configured to focus signals from PIC 520 onto sensor 660. Sensor 660 may be configured to detect measures of one or more of power levels of the signal through each lens of the alignment lens array 635, illumination levels of the signal through each lens of the alignment lens array 635, and intensity levels the signal through each lens of the alignment lens array 635. One or more processors of the optical communications terminal (e.g., the one or more processors discussed with respect to FIG. 5 including the first set of one or more processors 540 and the second set of one or more processors 550, the one or more processors 104, the one or more processors 203), may be configured to adjust or move the sensor 660 such that the sensor 660 is positioned at a target location of signals transmitted through the alignment lens array 635. The target location may be an in range or intended location of transmitted signals.

In some instances, the sensor 660 may be a camera (e.g., IR camera) or one or more photodiodes (PDs). In some instances, the sensor 660 may include a number of segments thereof each configured to detect a measure of one lens of the alignment lens array 635. For example, the sensor 660 may include four quadrants each configured to detect a measure of one of the four lenses 635a-d of the alignment lens array 635.

One or more processors of the optical communications terminal (e.g., the one or more processors discussed with respect to FIG. 5 including the first set of one or more processors 540 and the second set of one or more processors 550, the one or more processors 104, the one or more processors 203), may be further configured to receive measures from sensor 660. The one or more processors may be further configured to adjust or move the lens array 530 relative to the PIC 520 until at least one or more of power levels of the signal through each lens of the alignment lens array 635 is equal or approximately equal, illumination levels of the signal through each lens of the alignment lens array 635 is equal or approximately equal, and intensity levels of the signal through each lens of the alignment lens array 635 is equal or approximately equal. In this regard, the lens array may be aligned when the measures corresponding to each lens of the alignment lens array 635 are equal or approximately equal. The adjustments to the lens array 530 may be in at least one of the x-direction, the y-direction, and the z-direction relative of the lens array 530.

In some instances, where the lens array 530 includes a plurality of alignment lens arrays, the one or more processors may be configured to iteratively move the sensor 660 such that the sensor 660 is positioned at each target location of signals transmitted through each alignment lens array 635. Additionally, the one or more processors may be configured to iteratively adjust the lens array 530 until the measures of the lenses included in each alignment lens array are equal or approximately equal to the other lenses of their respective alignment lens array 635. For example, if the lens array 530 includes a first alignment lens array and a second alignment lens array. The sensor 660 may be positioned at a target location of signals transmitted through the first alignment lens array. The one or more processors may then be configured to adjust the lens array 530 until the measures corresponding to each lens in the first alignment lens array are equal or approximately equal. The sensor 660 may then be positioned at a target location of signals transmitted through the second alignment lens array. The one or more processors may then be configured to adjust the lens array 530 until the measures corresponding to each lens in the second alignment lens array are equal or approximately equal.

### Example Methods

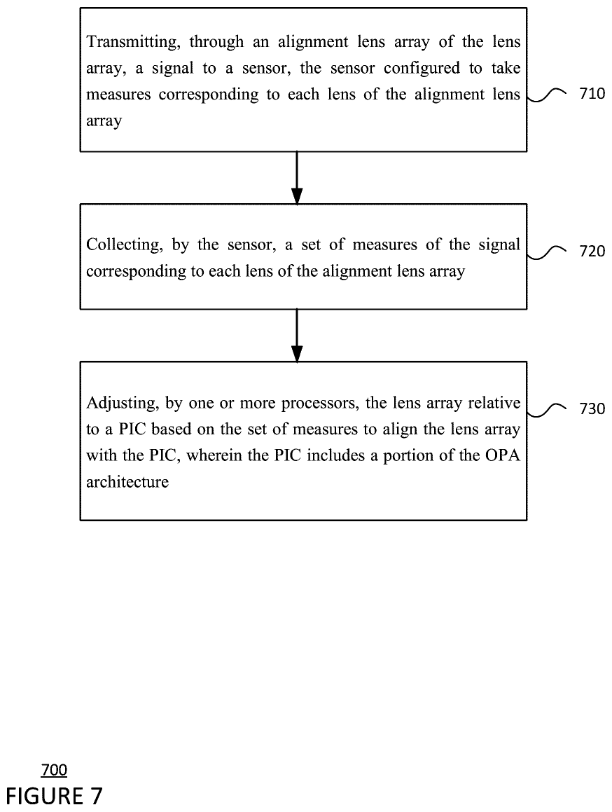

The systems described above may be used in a method of aligning a lens array. FIG. 7 illustrates and example method 700 of aligning a lens array of an OPA architecture. At block 710, the method includes transmitting, through an alignment lens array of the lens array, a signal to a sensor, the sensor configured to take measures corresponding to each lens of the alignment lens array. In this regard, one or more processors of the optical communications terminal (e.g., the one or more processors discussed with respect to FIG. 5 including the first set of one or more processors 540 and the second set of one or more processors 550, the one or more processors 104, and/or the one or more processors 203), operatively connected to an OPA architecture (e.g., OPA architecture 114, 300) may be configured to drive a plurality of phase shifters to transmit a signal through an alignment lens array 635 of a lens array 530. The OPA architecture of a portion thereof may be included a PIC 520. During alignment, the PIC 520 may be configured to transmit signals (e.g., optical signals) through the alignment lens array 635 towards sensor 660. Sensor 660 may be configured to detect measures of one or more of power levels of the signal through each lens of the alignment lens array 635, illumination levels of the signal through each lens of the alignment lens array 635, and intensity levels of a signal through each lens of the alignment lens array 635. The sensor 660 may include a number of segments thereof each configured to detect a measure of one lens of the alignment lens array 635. For example, the alignment lens array 635 may include four lenses 635a-d. In such an example, the sensor 660 may include four quadrants, each configured to detect a measure of one of the four lenses 635a-d of the alignment lens array 635.

In some instances, the alignment lens array 635 may be configured to transmit signals therethrough during alignment. The alignment lens array may be configured to not transmit signals therethrough during normal operation of the optical communications terminal (e.g., when transmitting and receiving signals to and from a remote terminal).

In some instances, the method may include positioning the sensor at a target location. In this regard, the sensor 660 to may be moved relative to the lens array 530 such that the sensor 660 is positioned at a target location of signals transmitted through the alignment lens array 635.

At block 720, the method includes collecting, by the sensor, a set of measures of the signal corresponding to each lens of the alignment lens array. In this regard, sensor 660 may be configured to detect measures of one or more of power levels of the signal through each lens of the alignment lens array 635, illumination levels of the signal through each lens of the alignment lens array 635, and intensity levels the signal through each lens of the alignment lens array 635. The measures corresponding to each lens of the alignment lens array 635 may be indicative of the alignment of the lens array 630. For example, if the measures of each lens of the alignment lens array 635 are equal or approximately equal, the lens array 530 may be aligned with the PIC 520. Similarly, if the measures of each lens of the alignment lens array 635 are not equal or approximately equal, the lens array 530 may not be aligned with the PIC 520.

At block 730, the method includes adjusting, by one or more processors, the lens array relative to a PIC based on the set of measures to align the lens array with the PIC, wherein the PIC includes a portion of the OPA architecture. In this regard, the one or more processors of the optical communications terminal (e.g., the one or more processors discussed with respect to FIG. 5 including the first set of one or more processors 540 and the second set of one or more processors 550, the one or more processors 104, the one or more processors 203), may be configured to receive measures from sensor 660. The one or more processors may be further configured to adjust or move the lens array 530 relative to the PIC 520 to align the lens array 530 with the PIC 520. In this regard, the lens array 530 may be adjusted or moved relative to the PIC until at least one or more of power levels of the signal through each lens of the alignment lens array 635 is equal or approximately equal, illumination levels of the signal through each lens of the alignment lens array 635 is equal or approximately equal, and intensity levels the signal through each lens of the alignment lens array 635 is equal or approximately equal. In this regard, the lens array 530 may be adjusted or more until the measures corresponding to each lens of the alignment lens array 635 are equal or approximately equal (e.g., within manufacturing standards). The adjustments to the lens array 530 may be in at least one of the x-direction, the y-direction, and the z-direction relative to the lens array 530.

In some instances, the adjustment may include transmitting, through the alignment lens array, additional signals to the sensor and collecting, by the sensor additional measures corresponding to each lens of the alignment lens array. In this regard, the method steps of block 710 and 720 may be repeated after individual adjustments to the lens array 530. For example, a first signal may be transmitted to the sensor 660, the sensor may collect a first set of measures corresponding to the first signal, and the one or more processors may make a first adjustment of the lens array 530 based on the first set of measures. Then, a second signal may be transmitted to the sensor 660 and the sensor may collect a second set of measures corresponding to the first signal. If each measure of the second set of measures is equal or approximately equal, the lens array 530 may be aligned with the PIC 520. Alternatively, if each measure of the second set of measures is not equal or approximately equal, the one or more processors may make a second adjustment of the lens array 530 based on the second set of measures.

In some instances, where the lens array 530 includes a plurality of alignment lens arrays, the method may be performed at each alignment lens array. In this regard, the one or more processors may be configured to iteratively adjust the lens array 530 until the measures of the lenses included in each alignment lens array are equal or approximately equal to the other lenses of their respective alignment lens array 635. For example, if the lens array 530 includes a first alignment lens array and a second alignment lens array, the method of aligning the lens array may include transmitting a first signal to the sensor 660 through a first alignment lens array, collecting a first set of measures corresponding to the first signal, adjusting the lens array 530 based on the first set of measures, transmitting a second signal to the sensor 660 through a second alignment lens array, collecting a second set of measures corresponding to the second signal, and adjusting the lens array 530 based on the second set of measures. In some instances, the method may further include transmitting a third signal to the sensor 660 through the first alignment lens array, collecting a third set of measures corresponding to the third signal, adjusting the lens array 530 based on the third set of measures. In this regard, following alignment of the lens array at the second alignment lens array, the alignment of the first alignment lens array may be re-verified.

The systems and methodology described herein allow for sub-micron alignment sensitivity required for lens arrays and PIC grating coupler applications. In this regard, the combination of passive fiducial structures and active differential elements in the form of the one or more alignment lens arrays included may allow for sub-micron alignment sensitivity The sub-micron alignment may enable lens alignment for lens arrays of various types including silicon carrier wafer grating types.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system for aligning a lens array of an optical phased array (OPA) architecture, the system comprising:
a photonic integrated circuit (PIC) comprising a portion of the OPA architecture, the portion of the OPA architecture being configured to transmit and receive signals through a lens array;
the lens array including an alignment lens array configured to transmit signals therethrough during alignment;
a sensor configured to collect measures corresponding to each lens of the alignment lens array, the measures being indicative of signals passing through the alignment lens array; and
one or more processors operatively connected to the pic, the lens array, and the sensor, the one or more processors configured to:
induce the OPA architecture to transmit signals through the alignment lens array, and
adjust the lens array relative to a PIC to align the lens array with the PIC based on the measures from the sensor.

2. The system of claim 1, wherein the alignment lens array is configured to not transmit signals therethrough during normal operation.

3. The system of claim 1, wherein the alignment lens array includes four lenses disposed in a symmetrical configuration.

4. The system of claim 1, wherein the lens array further includes a second alignment lens array.

5. The system of claim 4, wherein the alignment lens array and the second alignment lens array are in a symmetric configuration within the lens array.

6. The system of claim 1, wherein the one or more processors are further configured to move the sensor to a target location of the alignment lens array.

7. The system of claim 1, wherein the sensor is a camera or one or more photodiodes (PDs).

8. The system of claim 1, wherein the sensor includes a number of segments corresponding to the number of lenses in the alignment lens array.

9. The system of claim 8, wherein each segment is configured to detect a measure of one lens of the alignment lens array.

10. The system of claim 1, wherein the lens array is a micro-lens array of the OPA architecture.

11. The system of claim 1, wherein each lens of the alignment lens array has a diameter in a range of 13 μm to 120 μm.

12. A method of aligning a lens array of an OPA architecture, the method comprising:
transmitting, through an alignment lens array of the lens array, a signal to a sensor, the sensor configured to take measures corresponding to each lens of the alignment lens array;
collecting, by the sensor, a set of measures of the signal corresponding to each lens of the alignment lens array; and
adjusting, by one or more processors, the lens array relative to a PIC based on the set of measures to align the lens array with the PIC, wherein the PIC includes a portion of the OPA architecture.

13. The method of claim 12, wherein the adjusting of the lens array relative to the PIC occurs until the set of measures of the signal corresponding to each lens of the alignment lens array are equal.

14. The method of claim 12, wherein the set of measures includes at least one of power levels, illumination levels, or intensity levels.

15. The method of claim 12, wherein the adjusting of the lens array is in at least one of the x-direction, the y-direction, and the z-direction.

16. The method of claim 12, further comprising positioning, by the one or more processors, the sensor at a target location of the alignment lens array.

17. The method of claim 16, wherein the target location is an intended location of transmitted signals.

18. The method of claim 16, further comprising positioning, by the one or more processors, the sensor at a target location of a second alignment lens array.

19. The method of claim 12, further comprising:
transmitting, through a second alignment lens array of the lens array, a second signal to the sensor; and
collecting, by the sensor, a second set of measures of the signal corresponding to each lens of the second alignment lens array,
wherein adjusting, the lens array relative to the PIC is further based on the second set of measures.

20. The method of claim 19, further comprising:
transmitting, through the alignment lens array of the lens array, a third signal to the sensor; and
collecting, by the sensor, a third set of measures of the signal corresponding to each lens of the alignment lens array,
wherein adjusting, the lens array relative to the PIC is further based on the third set of measures.
